(19) United States
(12) Patent Application Publication
(10) Pub. No.: US 2025/0023770 A1
(43) Pub. Date: Jan. 16, 2025

(54) ELECTRONIC RED ENVELOPE SENDING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Fawei CHEN, Shenzhen (CN); Ziyan YAN, Shenzhen (CN)

(21) Appl. No.: 18/897,111

(22) Filed: Sep. 26, 2024

Related U.S. Application Data
(63) Continuation of application No. PCT/CN2023/088043, filed on Apr. 13, 2023.

(30) Foreign Application Priority Data
Nov. 14, 2022 (CN) 202211419949.6

(51) Int. Cl. H04L 41/08; G06F 3/0484; G06Q 20/42; G06Q 30/0601

(52) U.S. Cl. CPC H04L 41/08; G06F 3/0484; G06Q 30/0641; G06Q 20/42

(57) ABSTRACT

An electronic red envelope sending method includes displaying a message page of a client that includes a red envelope message and a red envelope re-sending control corresponding to the red envelope message, obtaining red envelope setting information corresponding to the red envelope message in response to a triggering operation performed on the red envelope re-sending control, and transmitting a red envelope re-sending message through the client based on the red envelope setting information.

### CROSS-REFERENCE TO RELATED APPLICATIONS

This application is a continuation of International Application No. PCT/CN2023/088043, filed on Apr. 13, 2023, which claims priority to Chinese Patent Application No. 202211419949.6, filed with the China National Intellectual Property Administration on Nov. 14, 2022 and entitled “ELECTRONIC RED ENVELOPE SENDING METHOD AND APPARATUS, ELECTRONIC DEVICE, AND STORAGE MEDIUM,” the entire contents of both of which are incorporated herein by reference.

### FIELD OF THE TECHNOLOGY

This application relates to the field of Internet technologies, and in particular, to an electronic red envelope sending method and apparatus, an electronic device, and a storage medium.

### BACKGROUND OF THE DISCLOSURE

Electronic red envelopes are widely applied in various social applications, significantly enriching interactions between users, and promoting development of social relationships among people.

Currently, each time a user wants to send an electronic red envelope, the user needs to manually set information about the red envelope, for example, a red envelope number and a red envelope amount, and a page for setting the information also needs to be manually opened by the user. The red envelope sending manner is very cumbersome, affecting efficiency of sending the electronic red envelope by the user.

### SUMMARY

In accordance with the disclosure, there is provided an electronic red envelope sending method including displaying a message page of a client that includes a red envelope message and a red envelope re-sending control corresponding to the red envelope message, obtaining red envelope setting information corresponding to the red envelope message in response to a triggering operation performed on the red envelope re-sending control, and transmitting a red envelope re-sending message through the client based on the red envelope setting information.

Also in accordance with the disclosure, there is provided an electronic red envelope sending method including displaying a message page of a client that includes a red envelope message, displaying a red envelope request control in response to a triggering operation performed on the red envelope message and all red envelopes in the red envelope message having been claimed, and transmitting, in response to a triggering operation performed on the red envelope request control, a red envelope re-sending request to another terminal corresponding to a user that transmits the red envelope message.

Also in accordance with the disclosure, there is provided an electronic device comprising at least one memory storing at least one application, and at least one processor configured to run the at least one application to display a message page of a client that includes a red envelope message and a red envelope re-sending control corresponding to the red envelope message, obtain red envelope setting information corresponding to the red envelope message in response to a triggering operation performed on the red envelope re-sending control, and transmit a red envelope re-sending message through the client based on the red envelope setting information.

### BRIEF DESCRIPTION OF THE DRAWINGS

To describe technical solutions of embodiments of this application more clearly, drawings required for describing the embodiments are briefly described below. Apparently, the drawings in the following description merely show some embodiments of this application, and a person skilled in the art may derive other drawings from the drawings without creative efforts.

FIG. 1 is a schematic diagram showing a scenario of an electronic red envelope sending method according to an embodiment of this application.

FIG. 2 is a flowchart of the electronic red envelope sending method according to an embodiment of this application.

FIG. 3 is a schematic diagram showing a message page according to an embodiment of this application.

FIG. 4 is a schematic diagram showing a user interface (UI) interaction of electronic red envelope sending according to an embodiment of this application.

FIG. 5 is a schematic diagram showing a user interface (UI) interaction of electronic red envelope sending according to an embodiment of this application.

FIG. 6 is a schematic diagram showing a technical implementation of red envelope re-sending message transmission according to an embodiment of this application.

FIG. 7 is a schematic diagram showing a user interface (UI) interaction of electronic red envelope sending according to an embodiment of this application.

FIG. 8 is a flowchart of an electronic red envelope sending method according to an embodiment of this application.

FIG. 9 is a schematic diagram showing another UI interaction of electronic red envelope sending according to an embodiment of this application.

FIG. 10 is a schematic diagram showing a technical implementation of red envelope sending request transmission according to an embodiment of this application.

FIG. 11 is a schematic flowchart of an electronic red envelope sending method according to an embodiment of this application.

FIG. 12 is a schematic diagram showing a technical implementation of a red envelope platform according to an embodiment of this application.

FIG. 13 is a schematic structural diagram of an electronic red envelope sending apparatus according to an embodiment of this application.

FIG. 14 is another schematic structural diagram of the electronic red envelope sending apparatus according to an embodiment of this application.

FIG. 15 is a schematic structural diagram of another electronic red envelope sending apparatus according to an embodiment of this application.

FIG. 16 is a schematic structural diagram of an electronic device according to an embodiment of this application.

### DESCRIPTION OF EMBODIMENTS

Technical solutions in embodiments of this application are clearly and completely described below with reference to drawings in the embodiments of this application. Apparently, the described embodiments are merely some rather than all of the embodiments of this application. All other embodiments obtained by a person skilled in the art based on the embodiments of this application without creative efforts fall within the protection scope of this application.

In this disclosure, the phrases “at least one of A, B, and C” and “at least one of A, B, or C” both mean only A, only B, only C, or any combination of A, B, and C.

The embodiments of this application provide an electronic red envelope sending method and apparatus, an electronic device, and a computer-readable storage medium. Specifically, an embodiment of this application provides an electronic red envelope sending method applicable to an electronic red envelope sending apparatus. The electronic red envelope sending apparatus may be integrated in an electronic device.

The electronic device may be a device such as a terminal, including but not limited to a mobile terminal and a fixed terminal. For example, the mobile terminal includes but is not limited to a smartphone, a smartwatch, a tablet computer, a laptop computer, or a smart on-board device. The fixed terminal includes but is not limited to a desktop computer or a smart television.

The electronic device may alternatively be a device such as a server. The server may be an independent physical server, or may be a server cluster composed of a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform. However, this application is not limited thereto.

The electronic red envelope sending method in this embodiment of this application may be implemented by the server, or may be jointly implemented by the terminal and the server.

The method is described below by using an example in which the electronic red envelope sending method is jointly implemented by the terminal and the server.

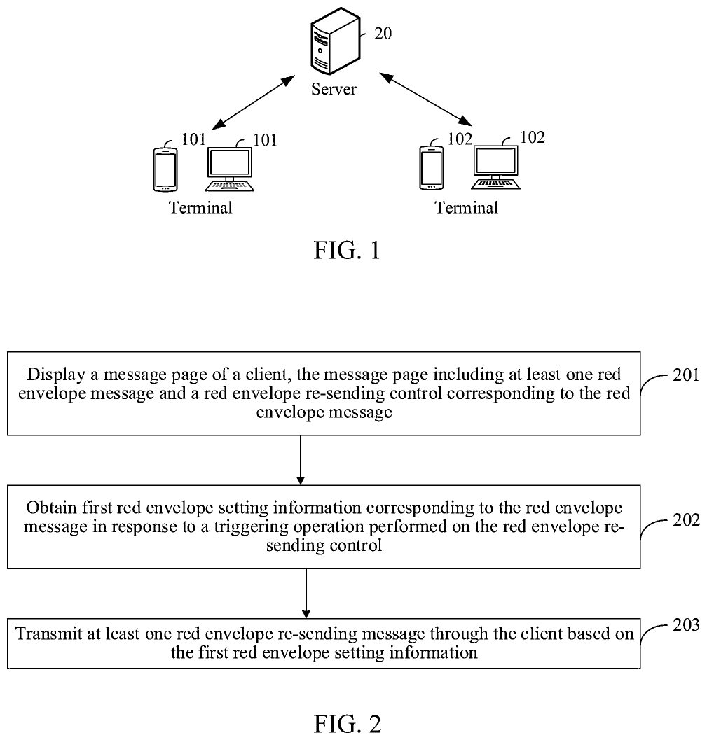

As shown in FIG. 1, an electronic red envelope sending system provided in this embodiment of this application includes a terminal 101, a terminal 102, a server 20, and the like. The terminal 101, the terminal 102, and the server 20 are connected through a network, for example, through a wired or wireless network. The terminal 101 may serve as a terminal used by a user that transmits a red envelope re-sending message.

The terminal 101 may be configured to: display a message page of a client, the message page including at least one red envelope message, a red envelope re-sending control being displayed in the red envelope message; obtain first red envelope setting information corresponding to the red envelope message in response to a triggering operation performed on the red envelope re-sending control; and transmit at least one red envelope re-sending message through the client based on the first red envelope setting information.

The server 20 may be configured to receive the red envelope re-sending message transmitted by the terminal 101 through the client, and transmit the red envelope re-sending message to the terminal 102.

The terminal 101 and the terminal 102 can display the red envelope re-sending message.

In some optional embodiments, the terminal 102 may be configured to: display a message page of a client, the message page including at least one red envelope message; display a red envelope request control in response to a triggering operation performed on the red envelope message if all red envelopes in the red envelope message are claimed; and transmit, in response to a triggering operation performed on the red envelope request control, a red envelope re-sending request to a user that transmits the red envelope message, so that the user that transmits the red envelope message transmits at least one red envelope re-sending message based on the red envelope re-sending request.

In some embodiments, the operation of transmitting the red envelope re-sending message performed by the server 20 may be performed by the terminal 101, which is not limited in this embodiment of this application.

According to the solution of this embodiment of this application, the message page of the client may be displayed, the message page including the at least one red envelope message and the red envelope re-sending control corresponding to the red envelope message, the first red envelope setting information corresponding to the red envelope message may be obtained in response to the triggering operation performed on the red envelope re-sending control, and the at least one red envelope re-sending message may be transmitted through the client based on the first red envelope setting information. In this embodiment of this application, when a user needs to send an electronic red envelope, the user may obtain information about a displayed red envelope by triggering the re-sending control, to send a new red envelope. In this way, the user does not need to set the red envelope from the very beginning, thereby simplifying operations for the user, and improving efficiency of sending the electronic red envelope by the user.

Detailed descriptions are provided below. A description order of the following embodiments is not construed as a preferred order of the embodiments.

This embodiment of this application is described from a perspective of an electronic red envelope sending apparatus. The electronic red envelope sending apparatus may be integrated in a terminal.

As shown in FIG. 2, a specific process of the electronic red envelope sending method in this embodiment may be as follows:

201: Display a message page of a client, the message page including at least one red envelope message and a red envelope re-sending control corresponding to the red envelope message.

The client may be any client that can display the red envelope message. For example, the client may be a client of instant messaging applications, or may be a client of social platform applications. Specifically, the client may be a web client, a mobile client, a game client, or the like. A type of the client is not limited in this embodiment of this application.

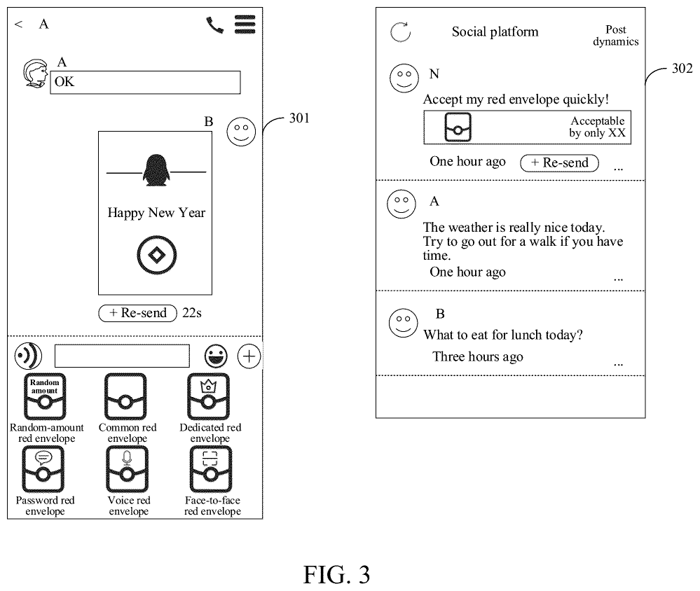

The message page may be a page provided by the client for a user to view various types of messages. For example, the message page may be a human-computer interaction page (a graphical user interface, GUI) of an instant messaging application shown in 301 in FIG. 3, or may be a GUI of a social platform application shown in 302 in FIG. 3.

Specifically, the red envelope message refers to a session message of a red envelope type, which is a session message presented in a form of a red envelope. The red envelope message may be a message of a red envelope type that may be triggered by the user of the client. The user may claim a red envelope in the red envelope message, view relevant information of the red envelope message (including but not limited to a user that has claimed the red envelope, an amount of each claimed red envelope in the red envelope message, and/or a time at which each red envelope is claimed), and the like by triggering the red envelope message.

Red envelope re-sending means sending a new red envelope based on a red envelope that was sent, i.e., transmitting a new red envelope message based on a displayed red envelope message. For example, a red envelope re-sending message identical with the displayed red envelope message is transmitted based on the displayed red envelope message. The red envelope re-sending control is a control that may be triggered by a user to quickly transmit a new red envelope message (i.e., a red envelope re-sending message). Specifically, the red envelope re-sending control may be in a form of a button, a dropdown menu, a message prompt, or the like. For example, the red envelope re-sending control may be a button named “+Re-send” shown in FIG. 3. Alternatively, the red envelope re-sending control may be in the form of a dropdown menu for the user to determine whether to transmit a new red envelope message. Alternatively, the red envelope re-sending control may be displayed in a form of a small gray bar in a session window to prompt the user to re-send a red envelope or not, or the like.

The red envelope re-sending message refers to a red envelope message retransmitted based on a red envelope message displayed on the message page. Overlapping content exists in red envelope setting information corresponding to the red envelope re-sending message and red envelope setting information corresponding to the red envelope message displayed on the message page. The overlapping content is directly obtained from the red envelope setting information corresponding to the displayed red envelope message. For example, the red envelope setting information of the red envelope re-sending message and the red envelope setting information of the displayed red envelope message are identical. Once the user triggers the re-sending control corresponding to the red envelope message, the user may quickly transmit the red envelope re-sending message based on first red envelope setting information corresponding to the red envelope message without a need of setting from the very beginning. The user uses the first red envelope setting information as the red envelope setting information corresponding to the red envelope re-sending message to transmit the red envelope re-sending message. Alternatively, the red envelope setting information of the red envelope re-sending message and the red envelope setting information of the displayed red envelope message are partially the same. Specifically, a red envelope amount of the red envelope re-sending message and a red envelope amount of the displayed red envelope message are the same. Once the user triggers the re-sending control corresponding to the red envelope message, the red envelope amount in the first red envelope setting information corresponding to the red envelope message is used as the red envelope amount in the red envelope setting information corresponding to the red envelope re-sending message. The user merely needs to set other content in the red envelope setting information corresponding to the red envelope re-sending message, to transmit the red envelope re-sending message. In this way, operations are simplified for the user. The overlapping content is directly obtained from the red envelope setting information corresponding to the displayed red envelope message, so that the user does not perform setting from the very beginning, thereby effectively improving efficiency of sending the electronic red envelope.

In some examples, the red envelope message configured with the corresponding red envelope re-sending control may be transmitted by any user, and the red envelope re-sending control may be triggered by any user. For example, a user A transmits a red envelope message. The red envelope message and a red envelope re-sending control corresponding to the red envelope message may be displayed in clients of the user A and a user B. The red envelope re-sending control may be triggered by the user A or the user B that sees the red envelope message.

In some other examples, the red envelope message configured with the corresponding red envelope re-sending control may be displayed in only a client that transmits the red envelope message, and the red envelope re-sending control may be triggered in only the client that transmits the red envelope message.

For example, the user A transmits a red envelope message. The red envelope message including a red envelope re-sending control may be displayed in a terminal of the user A, and the user A may quickly transmit a red envelope re-sending message by triggering the red envelope re-sending control. A terminal of the user B displays a red envelope message configured with no corresponding red envelope re-sending control.

In actual life, after a user transmits a red envelope message, other users often request the user to retransmit a plurality of red envelope messages. After a user transmits a red envelope message, if another user requests the user to retransmit the red envelope message, the user does not need to perform a cumbersome message interaction with the another user. Instead, the user may quickly obtain request details of the red envelope re-sending request based on a request detail viewing control. In this way, efficiency of obtaining information by the user is improved. To be specific, to help the user respond to the request of the other users and enhance the interaction between the users, before an operation “obtain first red envelope setting information corresponding to the red envelope message in response to a triggering operation performed on the red envelope re-sending control,” the electronic red envelope sending method provided in this embodiment of this application further includes:
receiving a red envelope re-sending request, and displaying a request detail viewing control in the red envelope message based on the red envelope re-sending request; and
displaying a request detail page in response to a triggering operation performed on the request detail viewing control, the request detail page including a user identifier of a requesting user that requests red envelope re-sending.

The red envelope re-sending request may be request information that can trigger the client to display the request detail viewing control in the red envelope message. Specifically, the red envelope re-sending request may be a request generated by the client based on content such as a voice, a text, or an image transmitted by another client, or may be a request generated by another client based on an operation of a user of the another client.

For example, after the user A transmits the red envelope message, the user B may input a text message “Send one more” through the client of the user B. In this case, the client of the user B may perform semantic recognition based on “Send one more,” generate a red envelope re-sending request based on a semantic recognition result, and forward the red envelope re-sending request to the client of the user A through a server, or transmit the red envelope re-sending request to the client of the user A directly, or the like.

Alternatively, the client of the user A may receive the text message “Send one more,” perform semantic recognition based on “Send one more,” and generate a red envelope re-sending request based on a semantic recognition result.

One or more red envelope re-sending request may be transmitted. A number of red envelope re-sending requests is not limited in this embodiment of this application.

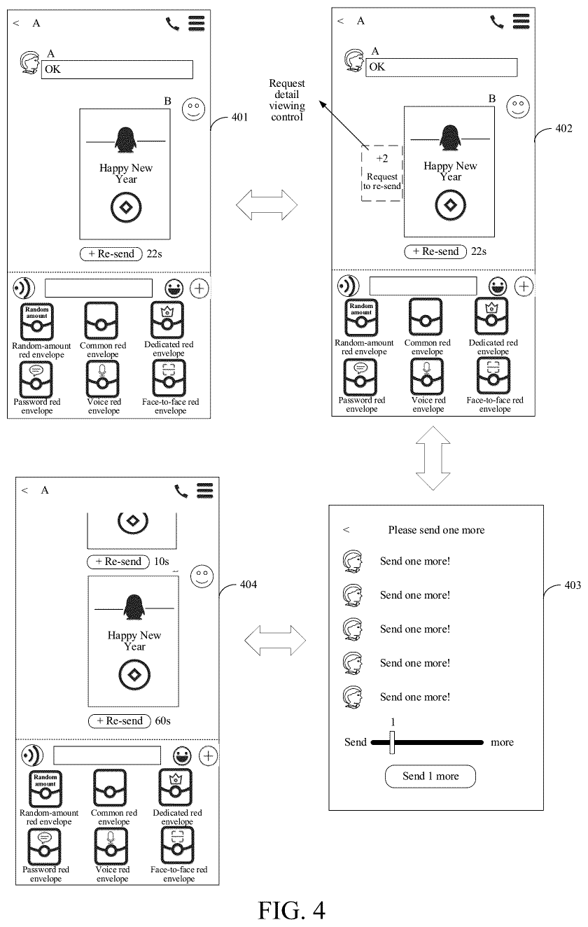

Specifically, the request detail viewing control may be triggered to view relevant information of the red envelope re-sending request. For example, the request detail viewing control may be shown as a control named “+2 Request to re-send” in 402 in FIG. 4.

In some embodiments, the request detail viewing control may be configured to be displayed in only a specific time period. For example, the request detail viewing control may be configured to be displayed within 60 s since receiving of a first red envelope re-sending request, or the request detail viewing control may be configured to be displayed within 60 s since transmission of the red envelope message.

After the specific time period ends, a display effect of the request detail viewing control may be changed. For example, the request detail viewing control is hidden in the red envelope message, or a color of the request detail viewing control is changed. For example, after the request detail viewing control is hidden, the message page may change from that shown in 402 in FIG. 4 to that shown in 401 in FIG. 4.

Specifically, the request detail page may be configured to display the relevant information of the red envelope re-sending request. The request detail page may display the user identifier (for example, a user avatar or a user nickname) of the requesting user that transmits the red envelope re-sending request and/or a number of red envelope re-sending requests, but this application is not limited thereto.

For example, the request detail page may be shown in 403 in FIG. 4.

In some examples, in the request detail page, personalized information of the red envelope re-sending message may be set through the red envelope re-sending setting control, thereby further ensuring that a new red envelope is sent based on a demand of the red envelope sender while ensuring quick sending of the new red envelope. In this way, flexibility of sending the electronic red envelope is improved. In other words, the request detail page may further include the red envelope re-sending setting control. The electronic red envelope sending method provided in this embodiment of this application may further include:
determining third red envelope setting information in response to a triggering operation performed on the red envelope re-sending setting control;
obtaining the first red envelope setting information corresponding to the red envelope message; and
transmitting the at least one red envelope re-sending message through the client based on the first red envelope setting information and the third red envelope setting information.

Specifically, the number of red envelope re-sending messages, a number of red envelopes in the red envelope re-sending message, a red envelope amount, a type of the red envelope re-sending message, and/or the like may be set through the triggering operation performed on the red envelope re-sending setting control.

For example, the red envelope re-sending setting control may be shown as a bar control corresponding to “1” in 403 in FIG. 4. The number of red envelope re-sending messages may be set through sliding of the bar control.

As another example, the red envelope re-sending setting control may be set to an area corresponding to the request detail page. The number of red envelopes in the red envelope re-sending message, and the red envelope amount, and the like may be set through a sliding operation, a handwriting operation, or the like performed on the request detail page. A specific setting manner may be set by a technical person or a user.

The third red envelope setting information may include but is not limited to the number of red envelope re-sending messages, the number of red envelopes in the red envelope re-sending message, the red envelope amount, and/or the type of the red envelope re-sending message. In some examples, the third red envelope setting information may be all setting information of the red envelope re-sending message.

In some other examples, the third red envelope setting information may be a part of the setting information of the red envelope re-sending message. In this case, the setting information of the red envelope re-sending message may be supplemented based on the first red envelope setting information, to obtain all of the setting information of the red envelope re-sending message.

Generally, a red envelope re-sending request is in correspondence with a red envelope message. Therefore, content displayed on the request detail page may be obtained based on the correspondence.

In some embodiments, in a message page of a client of the requesting user, the red envelope message may be configured with a corresponding red envelope request control. In this case, the correspondence between the red envelope re-sending request and the red envelope message may be established based on a triggering operation performed by the requesting user.

In some other embodiments, if the red envelope re-sending request is generated based on a text, a voice, or the like transmitted by the requesting user, the correspondence between a red envelope re-sending request and the red envelope message may be determined based on a time at which the requesting user transmits the message, a time at which the red envelope message is transmitted, or may be determined based on message content of the requesting user, or the like.

For example, transmission time of a red envelope message 1 is 21:40, transmission time of a red envelope message 2 is 21:42, and time at which the requesting user transmits the message is 21:41. In this case, it may be considered that the red envelope message corresponding to the red envelope re-sending request is the red envelope message 1.

As another example, content parsing may be performed on the message content of the requesting user. The correspondence between the red envelope re-sending request and the red envelope message may be determined based on a correlation between associated information corresponding to each red envelope message and a content parsing result. If the user A transmits the red envelope message 1, the user B transmits the red envelope message 2, and a message transmitted by a user C includes content related to the user B or the red envelope message 2, it may be considered that the red envelope message corresponding to the red envelope re-sending request is the red envelope message 2.

For example, the message transmitted by the user C may be “@ User B Send one more.” In this case, it may be determined that a high correlation exists between message content of the user C and the user B, and therefore the red envelope message corresponding to the red envelope re-sending request is the red envelope message 2.

Alternatively, the red envelope message 1 includes 10 electronic red envelopes, the red envelope message 2 includes 6 electronic red envelopes, and the message transmitted by the user C may be “6 is not enough. Send a few more . . . ” In this case, correlations between “6” in the message content and the associated information “10” of the red envelope message 1 and the associated information “6” of the red envelope message 2 may be determined, thereby determining that a high correlation exists between the message content of the user C and the red envelope message 2. Therefore, the red envelope message corresponding to the red envelope re-sending request is the red envelope message 2.

During an actual application, the red envelope message may be a message in which a red envelope receiving object (i.e., a red envelope recipient) is specified. In other words, the electronic red envelope in the red envelope message can be claimed by only an object that satisfies a specific condition. The red envelope message may alternatively be a message in which no red envelope receiving object is specified.

Therefore, before the red envelope re-sending message is transmitted, the red envelope receiving object of the red envelope re-sending message may be adjusted. In the request detail page, the receiving object of the red envelope re-sending message may be set through a receiving object setting control, and the receiving object is the requesting user that transmits the red envelope re-sending request, thereby further ensuring that a new red envelope is sent based on demands of both parties while ensuring quick sending of the new red envelope. In this way, the flexibility of sending the electronic red envelope is improved. To be specific, the red envelope re-sending setting control includes a receiving object setting control corresponding to each requesting user, and the operation “determine third red envelope setting information in response to a triggering operation performed on the red envelope re-sending setting control” may specifically include:
determining, in response to a triggering operation performed on at least one receiving object setting control, a requesting user corresponding to the receiving object setting control as the red envelope receiving object; and
determining the third red envelope setting information based on object information of the red envelope receiving object.

The red envelope receiving object is a user that can receive the electronic red envelope in the red envelope re-sending message. Specifically, the red envelope receiving object may be an individual user, a group, or the like. A number of red envelope receiving objects may be set by the user.

For example, the receiving object setting control may be the user identifier of the requesting user on the request detail page. Through triggering of a user identifier of a requesting user, the red envelope type of the red envelope re-sending message may be set to a specific red envelope that can be claimed by only the requesting user. Condition information indicating that only the requesting user can claim the red envelope is added to the third red envelope setting information.

If the red envelope receiving object is not set, the red envelope receiving object of the red envelope re-sending message may be the same as the red envelope receiving object of the red envelope message.

For example, the red envelope type of the red envelope message is a common red envelope. To be specific, any user can trigger the red envelope message to claim the electronic red envelope in the red envelope message. Through the triggering operation performed on the receiving object setting control, the red envelope re-sending message may be set to a specific red envelope that can be claimed by only a specific object.

In some optional embodiments, the user may view the relevant information of the red envelope re-sending request by triggering the red envelope message. After a user transmits a red envelope message, if another user requests the user to retransmit the red envelope message, the user does not need to perform a cumbersome message interaction with the another user. Instead, the user may quickly obtain details of the requesting user of the red envelope re-sending request by triggering the transmitted red envelope message. In this way, the efficiency of obtaining information by the user is improved. To be specific, before the operation “obtain first red envelope setting information corresponding to the red envelope message in response to a triggering operation performed on the red envelope re-sending control,” the electronic red envelope sending method provided in this embodiment of this application may further include:
displaying a red envelope detail page in response to a triggering operation performed on the red envelope message, the red envelope detail page including the user identifier of the requesting user that requests red envelope re-sending, and the user identifier of the requesting user being obtained through a red envelope re-sending request transmitted by a client of the requesting user.

In some embodiments, the red envelope detail page may further include an claiming status of the electronic red envelope of the red envelope message, a number of requests corresponding to each requesting user, and the like.

To avoid a waste of terminal resources as a result of a misoperation of the user after a time period, the red envelope re-sending message is allowed to be transmitted through the red envelope re-sending control only within a time period since the transmission of the red envelope message. After the time expires, the display effect of the red envelope re-sending control may be modified. In other words, the electronic red envelope sending method provided in this embodiment of this application may further include:
obtaining a message transmission duration of the red envelope message, and adjusting a display effect of the red envelope re-sending control when the message transmission duration is greater than the preset red envelope re-sending duration.

Specifically, the red envelope re-sending duration is a time length in which transmission of the red envelope re-sending message through the red envelope re-sending control is allowed. The red envelope re-sending duration may be set by the user or a technical person, which is not limited in this embodiment of this application.

The adjusting a display effect of the red envelope re-sending control may include but is not limited to hiding the red envelope re-sending control, and modifying a color of the red envelope re-sending control.

To prompt the user to perform operations in the red envelope re-sending duration, in some embodiments, the red envelope re-sending control may be configured with a corresponding red envelope re-sending countdown, and the red envelope re-sending countdown is less than or equal to the preset red envelope re-sending duration.

The red envelope re-sending countdown may be “10 s” or “60 s” shown in 404 in FIG. 4.

In some embodiments, different red envelope re-sending messages may correspond to different red envelope re-sending durations. For example, a red envelope re-sending duration for the user to transmit a first red envelope re-sending message may be 60 s, and a red envelope re-sending duration for the user to transmit a second red envelope re-sending message may be 30 s.

To facilitate operations for the user, even though the red envelope re-sending duration is defined, if the user that sends the red envelope triggers the red envelope re-sending control in the red envelope re-sending duration, even if time after the triggering is enabled expires the red envelope re-sending duration, the user can still send a red envelope, as long as the user does not exit a relevant red envelope re-sending page.

202: Obtain first red envelope setting information corresponding to the red envelope message in response to a triggering operation performed on the red envelope re-sending control.

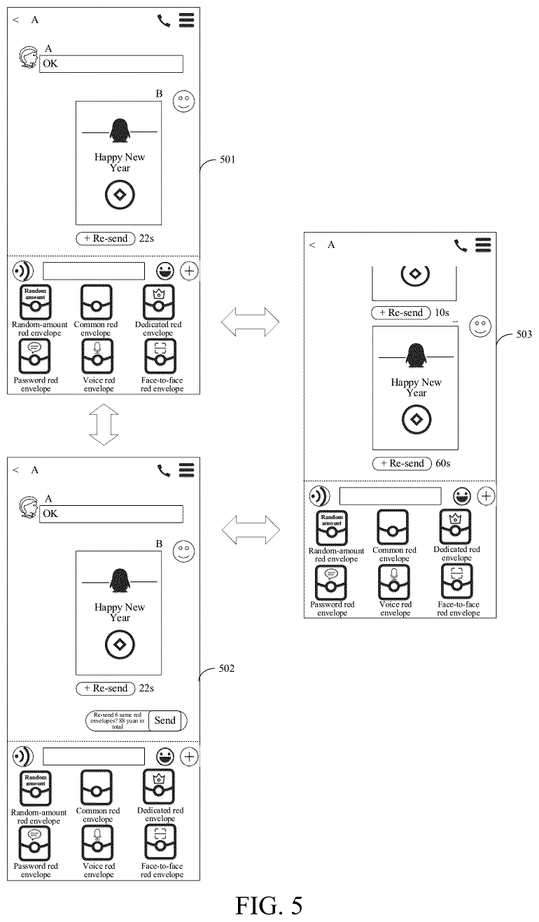

The triggering operation performed on the red envelope re-sending control may be an independent operation. As shown in FIG. 5, the triggering operation may be a clicking/tapping operation performed on a control “+Re-send” shown in 501 in FIG. 5. For example, the user may directly transmit the red envelope re-sending message through the client by triggering the control “+Re-send” (i.e., the red envelope re-sending control). The client may display a message page shown in 503 in FIG. 5.

Alternatively, to avoid a waste of terminal resources as a result of a misoperation of the user, the triggering operation may be a set of continuous operations. As shown in FIG. 5, the triggering operation may include a first triggering sub-operation performed on the control “+Re-send” in 501 in FIG. 5 and a second triggering sub-operation performed on a control “Send” in 502 in FIG. 5.

In other words, the operation “obtain first red envelope setting information corresponding to the red envelope message in response to a triggering operation performed on the red envelope re-sending control” may specifically include:
displaying a re-sending confirmation control in response to the triggering operation performed on the red envelope re-sending control; and
obtaining the first red envelope setting information corresponding to the red envelope message in response to a triggering operation performed on the re-sending confirmation control.

For example, the red envelope re-sending control may be the control “+Re-send” in 501 in FIG. 5, and the re-sending confirmation control may be the control “Send” in 502 in FIG. 5.

The triggering operation may include operation forms such as clicking/tapping, double clicking/tapping, touching and holding, and sliding. In some examples, the triggering of the control may be achieved through a preset shortcut operation. For example, that a user of a terminal presses a volume down button once may be considered as a triggering operation on the control “+Re-send.” A specific shortcut operation is not limited in this embodiment of this application.

In some optional embodiments, to help the user control the message number of red envelope re-sending messages, the users may set the number through the red envelope re-sending control. In other words, the operation “obtain first red envelope setting information corresponding to the red envelope message in response to a triggering operation performed on the red envelope re-sending control” may include:
displaying a number prompt identifier in response to a re-sending number setting operation performed on the red envelope re-sending control, the number prompt identifier indicating a message number of red envelope re-sending messages corresponding to the re-sending number setting operation; and
obtaining the first red envelope setting information corresponding to the red envelope message in response to a number setting ending event.

The re-sending number setting operation is a triggering operation performed on the red envelope re-sending control, and is configured for setting the message number of red envelope re-sending messages, i.e., the number of red envelope re-sending messages. The re-sending number setting operation may be a sliding operation performed on the red envelope re-sending control, or may be a sliding operation for touch and hold control of the red envelope re-sending control, or the like. For example, the red envelope re-sending control may be slid leftward through touching and holding to reduce the message number of red envelope re-sending messages, and the red envelope re-sending control may be slid rightward through touching and holding to increase the message number of red envelope re-sending messages. As shown in FIG. 5, the re-sending number setting operation may be a sliding operation performed on the control “+Re-send” in 501 in FIG. 5 performed through touching and holding control. The user may slide the control “+Re-send” leftward through touching and holding to reduce the message number of red envelope re-sending messages, and may slide the control “+Re-send” rightward through touching and holding to increase the message number of red envelope re-sending messages.

The number setting ending event is an event indicating that the setting of the message number of red envelope re-sending messages is completed. If the number prompt identifier does not change within a preset time, the number setting ending event may be generated and triggered. For example, if the number prompt identifier does not change within 10 s, the number setting ending event is generated, and the number setting ending event is triggered. After the re-sending number setting operation is completed, the number setting ending event may be generated and triggered. For example, the re-sending number setting operation may be a sliding operation performed on the red envelope re-sending control. Once the sliding operation performed on the red envelope re-sending control is completed, the number setting ending event is generated, and the number setting ending event is triggered. In another embodiment, the red envelope re-sending control may be the red envelope message. To be specific, red envelope re-sending can be achieved through triggering of the red envelope message. For example, a red envelope re-sending prompt may be displayed through touching and holding of the red envelope message, and a red envelope message setting interface is opened after a confirmation operation performed by the user is received.

During an actual application, the red envelope setting information of the red envelope re-sending message may be obtained based on the first red envelope setting information, the red envelope amount in the first red envelope setting information is used as the red envelope amount in the red envelope setting information of the red envelope re-sending message, and the red envelope receiving object in the first red envelope setting information is used as the red envelope receiving object in the red envelope setting information of the red envelope re-sending message. Further, the user may pay for an order for the red envelope re-sending message. In other words, the operation “transmit at least one red envelope re-sending message through the client based on the first red envelope setting information” may specifically include:
determining fourth red envelope setting information corresponding to the red envelope re-sending message based on the first red envelope setting information, the fourth red envelope setting information including red envelope payment information and the object information of the red envelope receiving object;
generating a payment order corresponding to the red envelope re-sending message based on the red envelope payment information, and performing a payment confirmation operation on the payment order;
transmitting, through the client, the at least one red envelope re-sending message to a client of the red envelope receiving object based on the object information.

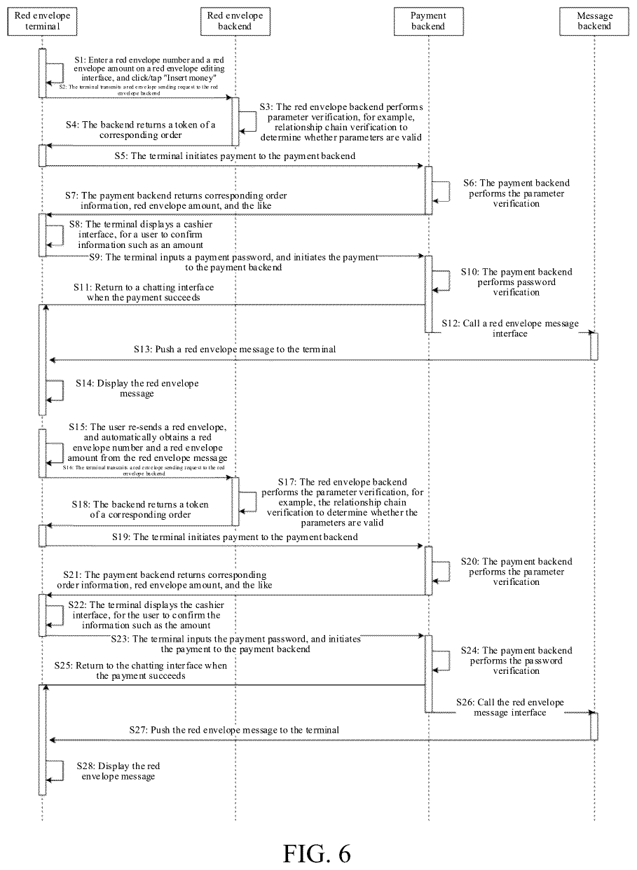

In an embodiment, as shown in FIG. 6, during first sending of a red envelope, a user enters a red envelope number and a red envelope amount on a red envelope editing interface, and clicks/taps “Insert money,” and a red envelope terminal transmits a red envelope request to a red envelope backend. The red envelope backend performs verification on relevant parameters of the red envelope request. For example, the red envelope backend may perform relationship chain verification, to perform verification on whether an association exists between a party that transmits the red envelope request and a party that receives the red envelope request (i.e., a red envelope receiving object). If the association exists, the relevant parameters of the red envelope request are valid, and therefore the verification succeeds. If the association does not exist, the relevant parameters of the red envelope request are abnormal, and therefore the verification fails. An object identifier of the red envelope receiving object includes at least one of an object identifier of a current session object corresponding to the message page and an object identifier of an associated object associated with a logged-in account in the client. If the verification succeeds, the red envelope backend returns a token of a corresponding order to the red envelope terminal. If the verification fails, the red envelope backend does not process the red envelope request.

After receiving the token of the order, the red envelope terminal initiates payment to a payment backend. The payment backend performs verification on relevant parameters of the order. For example, the payment backend may perform verification on whether correct information is entered on the order. If the verification succeeds, the payment backend returns information such as the corresponding order information and red envelope amount to the red envelope terminal. The red envelope terminal displays a cashier interface. The cashier interface is configured for confirming relevant information on the cashier interface, for example, the red envelope amount. After confirming the information, the user enters a payment password on the red envelope terminal, so that the red envelope terminal initiates payment to the payment backend. The payment backend performs verification on the payment password. If the verification succeeds, the payment backend returns a payment success to the red envelope terminal, so that the red envelope terminal returns to a chatting interface from a payment interface. The payment backend further needs to call a red envelope message interface, and push the red envelope message to the red envelope terminal through a message backend, so that the red envelope terminal displays the red envelope message.

After the user sends a red envelope, since the red envelope message has information related to the red envelope stored therein, during quick red envelope re-sending, when the user clicks/taps or touches and holds a message bubble to initiate “Quickly re-send a red envelope,” the red envelope terminal may obtain information such as a red envelope number and a red envelope amount from the red envelope message, enter red envelope information based on the information, and directly transmit a red envelope request to the red envelope backend.

Processing performed by the red envelope backend, the payment backend, and the message backend on different red envelope requests is similar.

203: Transmit at least one red envelope re-sending message through the client based on the first red envelope setting information.

The red envelope re-sending message may actually be understood as a special red envelope message, from which a red envelope receiving object of the red envelope re-sending message can claim an electronic red envelope. The red envelope setting information of the red envelope re-sending message may be the same as or different from the first red envelope setting information of the original red envelope message. The transmitting at least one red envelope re-sending message through the client means retransmitting at least one new red envelope message through the client.

During an actual application, a display form of the red envelope re-sending message may be the same as or different from that of a common red envelope message. For example, a red envelope cover of the red envelope re-sending message may be configured with identification information indicating that the red envelope message is a red envelope re-sending message and the like.

In some examples, the red envelope re-sending control may be a control that can achieve a “red envelope solitaire” effect. The user may transmit the red envelope re-sending message by triggering the red envelope re-sending control, and such type of red envelope re-sending message can form a solitaire with the red envelope message corresponding to the red envelope re-sending control.

After the user triggers the red envelope re-sending control, the red envelope message setting interface may be displayed to help the user set the red envelope re-sending message solitaire.

A red envelope re-sending message that achieves the “red envelope solitaire” effect may be configured with a solitaire information prompt, to display relevant solitaire information of the red envelope re-sending message. For example, after the user A transmits the red envelope message 1, the user B may form a red envelope solitaire for the red envelope message 1. The user B transmits a red envelope re-sending message 2. Relevant solitaire information of the red envelope re-sending message 2, for example, “The user B forms a solitaire of the red envelope of the user A,” may be displayed in the client in a form of a small gray bar.

In some embodiments, the relevant solitaire information may be viewed through the triggering of the red envelope re-sending message. For example, after another user clicks/taps the red envelope re-sending message 2 of the user B, the relevant solitaire information may be displayed on a red envelope claiming page of the red envelope re-sending message 2.

When two or more pieces of relevant solitaire information exist, the relevant solitaire information may be folded. For example, the user A transmits the red envelope message 1, the user B transmits the red envelope re-sending message 2 to form a red envelope solitaire for the red envelope message 1, and the user C transmits a red envelope re-sending message 3 to form a red envelope solitaire for the red envelope re-sending message 2. In this case, the relevant solitaire information of the red envelope re-sending message 2 may be “The user B forms a solitaire for the red envelope of the user A” and “The user C forms a solitaire for the red envelope of the user B,” or may be either of “The user B forms a solitaire for the red envelope of the user A” and “The user C forms a solitaire for the red envelope of the user B.” A specific folding rule may be set by a technical person or the user, which is not limited in this embodiment of this application.

In some embodiments, a display order of the relevant solitaire information may be set by a technical person or the user. For example, the display order may be set based on sending time of solitaire red envelopes, time at which users that send the solitaire red envelopes join a group, or electronic red envelope amounts of the solitaire red envelopes, or the like.

For example, the relevant solitaire information of the red envelope re-sending message 2 may be “The user B forms a solitaire for the red envelope of the user A” followed by “The user C forms a solitaire for the red envelope of the user B,” or may be “The user B forms a solitaire for the red envelope of the user A” following “The user C forms a solitaire for the red envelope of the user B.”

In some optional embodiments, the first red envelope setting information may be directly used as the setting information of the red envelope re-sending message. During the transmission of the red envelope re-sending message, information required for transmitting the red envelope re-sending message may be directly entered based on the first red envelope setting information.

In some other optional embodiments, to help the red envelope re-sending message more flexibly, the user may modify the first red envelope setting information. To be specific, the operation “transmit at least one red envelope re-sending message through the client based on the first red envelope setting information” includes:
displaying a red envelope message setting page based on the first red envelope setting information, the red envelope message setting page including the first red envelope setting information;
determining second red envelope setting information in response to an information modification operation directed to the first red envelope setting information on the red envelope message setting page; and
transmitting the red envelope re-sending message through the client based on the second red envelope setting information, setting information of the red envelope re-sending message including the second red envelope setting information.

For example, relevant information of the red envelope setting may be entered based on the first red envelope setting information on the red envelope message setting page. The user may modify all or a part of the first red envelope setting information based on information displayed on the page.

For example, the first red envelope setting information may be a red envelope number of 5, a total red envelope amount of 16 yuan, and a red envelope type of random-amount red envelope. The user may modify the total red envelope amount to 18.8 yuan on the red envelope message setting page.

In some embodiments, the first red envelope setting information and the second red envelope setting information each may include at least one of a red envelope number, a red envelope amount, a red envelope type, a red envelope cover, and a red envelope remark. The second red envelope setting information may further include but is not limited to information such as the message number of red envelope re-sending messages.

The red envelope cover is a user interface (UI) during display of the red envelope re-sending message.

The red envelope remark is customized remark information such as a text, a voice, or an image set by the user for the red envelope re-sending message. For example, the red envelope remark may be “Happy New Year” shown in 401 in FIG. 4.

The red envelope type may be a dedicated red envelope, a common red envelope, a voice red envelope, or the like.

For example, first red envelope setting information of a red envelope message may be a red envelope number of 5, a total red envelope amount of 16 yuan, and a red envelope type of random-amount red envelope. Through an information modification operation, a user may transmit 6 red envelope re-sending messages, each having a red envelope number of 6, a red envelope amount of 6 yuan, and a red envelope type of a common red envelope.

In some optional embodiments, the user may transmit the red envelope re-sending message on a current message page, or may transmit the red envelope re-sending message to another object. To be specific, before the operation “transmit at least one red envelope re-sending message through the client,” the electronic red envelope sending method provided in this embodiment of this application may further include:
displaying a red envelope receiving object selection page, the red envelope receiving object selection page including an object identifier of at least one red envelope receiving object; and
determining at least one target red envelope receiving object in response to a selection operation performed on the object identifier on the red envelope receiving object selection page.

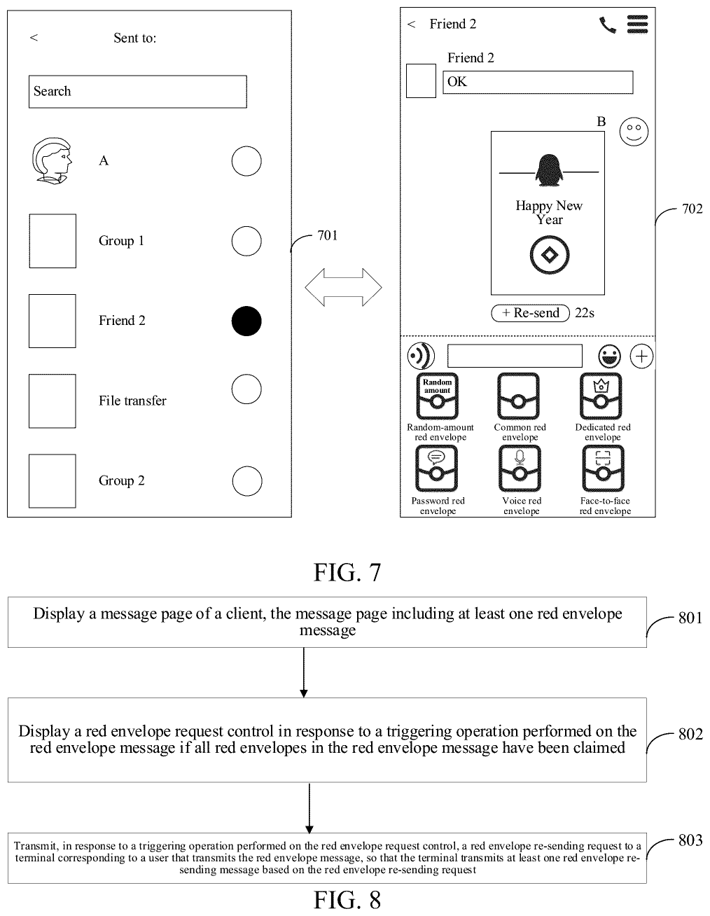

Specifically, the red envelope receiving object selection page may be displayed based on a triggering operation such as a touching and holding operation performed on the red envelope message. As shown in 701 in FIG. 7, the red envelope receiving object selection page may include an object identifier such as an avatar of each red envelope receiving object. If a “Friend 2” shown in 701 in FIG. 7 is selected, the red envelope re-sending message may be transmitted to the “Friend 2,” as shown in 702 in FIG. 7.

The target red envelope receiving object may be an individual user, a group, or the like.

In some embodiments, the object identifier may include but is not limited to an object name and an identification image corresponding to the object (for example, an avatar of an individual user or an avatar of a group).

Specifically, the object identifier of the red envelope receiving object includes at least one of an object identifier of a current session object corresponding to the message page and an object identifier of an associated object associated with a logged-in account in the client.

When the client is an instant messaging application client, if the message page is currently a session message page between the logged-in account in the client and another user, the current session object corresponding to the message page is an individual user in a session with a user corresponding to the logged-in account.

If the message page is currently a session message page between the user corresponding to the logged-in account and a group object, the current session object corresponding to the message page may be the group object, or may be an individual user in the group object chatting with the user corresponding to the logged-in account, or may be an individual user in the group object that is a friend of the logged-in account, or the like.

Specifically, when the client is an instant messaging application client or a social platform application client, the object identifier of the red envelope receiving object may be the object identifier of the associated object. The associated object is an object in an association relationship with the logged-in account in the client. For example, in an instant messaging application, the associated object may be a friend of the logged-in account. Alternatively, in a social platform application, the associated object may be a fan of the logged-in account.

In some optional examples, the association relationship between the associated object and the logged-in account may be established through a plurality of different applications. For example, an associated object P may be a user of an application A, which has established an account in an instant messaging application B, a logged-in account S of a user is an account registered with the instant messaging application B, and user logs in the application A by using the account S. If the associated object is a friend of the logged-in account S in the application A, it may be considered that the associated object P has an association relationship with the logged-in account S in the application B.

During an actual application, a display arrangement of the object identifiers on the red envelope receiving object selection page may be determined based on a preset display rule. For example, the display rule may be displaying the object identifiers in descending order of frequencies of sessions with the user of the logged-in account, or displaying the object identifiers in descending order of time of sessions with the user of the logged-in account.

Correspondingly, the red envelope re-sending message may be transmitted to the target red envelope receiving object. To be specific, the operation “transmit at least one red envelope re-sending message through the client” includes:
transmitting the at least one red envelope re-sending message to the target red envelope receiving object through the client.

After the red envelope re-sending message is transmitted through the client, the red envelope re-sending message may be displayed in the client of the user that transmits the red envelope re-sending message.

It may be learned from the above that, in this embodiment of this application, the message page of the client may be displayed, the message page including the at least one red envelope message, the red envelope re-sending control being displayed in red envelope message; the first red envelope setting information corresponding to the red envelope message is obtained in response to the triggering operation performed on the red envelope re-sending control; and the at least one red envelope re-sending message is transmitted through the client based on the first red envelope setting information. In this embodiment of this application, when a user needs to send an electronic red envelope, the user may obtain information about a displayed red envelope by triggering the re-sending control, to send a new red envelope. Through this embodiment of this application, the user does not need to set the red envelope from the very beginning, thereby improving efficiency of sending the electronic red envelope by the user.

As shown in FIG. 8, an embodiment of this application provides another electronic red envelope sending method. The electronic red envelope sending method may specifically be performed by a terminal. A specific process is as follows:

801: Display a message page of a client, the message page including at least one red envelope message.

The client in this embodiment of this application is a client used by a requesting user, and the requesting user is a user that requests another user to transmit a red envelope re-sending message.

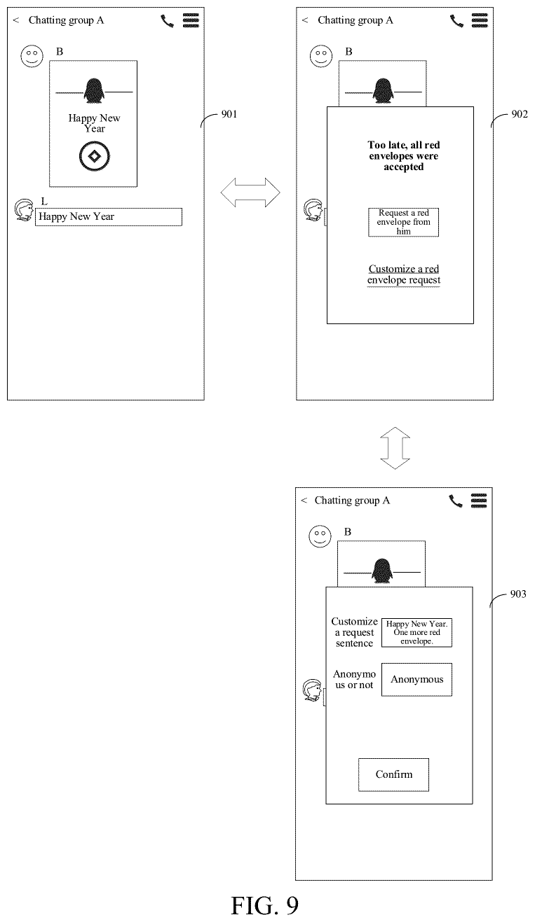

For example, the message page of the client may be shown in 901 in FIG. 9.

802: Display a red envelope request control in response to a triggering operation performed on the red envelope message if all red envelopes in the red envelope message have been claimed.

During an actual application, a red envelope message that can display the red envelope request control is generally not transmitted by a requesting user.

Specifically, the red envelope request control may be a control named “Request a red envelope from him” or “Customize a red envelope request” in 902 in FIG. 9.

An electronic red envelope in the red envelope message may be claimed or not claimed by the requesting user, which is not limited in this embodiment of this application.

803: Transmit, in response to a triggering operation performed on the red envelope request control, a red envelope re-sending request to a terminal corresponding to a user that transmits the red envelope message, so that the terminal transmits at least one red envelope re-sending message based on the red envelope re-sending request.

The red envelope re-sending request may include information such as a user identifier of the requesting user.

In some optional embodiments, the requesting user may add customized content such as a specific request sentence to the red envelope re-sending request, to enrich content of the red envelope re-sending request, achieve transmission of a personalized red envelope re-sending request, and improve flexibility of the red envelope re-sending request. In other words, the operation “transmit, in response to a triggering operation performed on the red envelope request control, a red envelope re-sending request to a terminal corresponding to a user that transmits the red envelope message” may specifically include:
displaying a request information setting page in response to the triggering operation performed on the red envelope request control;
determining red envelope request information in response to a request information setting operation performed on the request information setting page; and
generating the red envelope re-sending request based on the red envelope request information, and transmitting the red envelope re-sending request to the terminal corresponding to the user that transmits the red envelope message.

Specifically, the request information setting page may be shown in 903 in FIG. 9. For example, the requesting user may set a customized request sentence on the request information setting page, and may select an anonymous request or a real-name request.

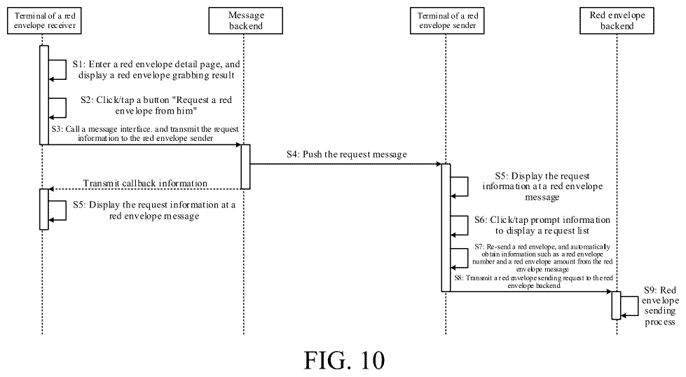

Specifically, a specific process of requesting the red envelope re-sending message may be shown in a flowchart in FIG. 10. A red envelope receiver may grab a red envelope on a terminal. During the grabbing of the red envelope, the terminal of the red envelope receiver enters a red envelope detail page. A red envelope grabbing result is displayed on the red envelope detail page. If all red envelopes are grabbed, the red envelope detail page may include a button “Request a red envelope from him.” The red envelope receiver may trigger the button “Request a red envelope from him” to request a red envelope from a red envelope sender. If the red envelope receiver triggers the button “Request a red envelope from him,” the terminal of the red envelope receiver calls a message interface, and transmits request information (or a request message) to the red envelope sender through a message backend. The message backend pushes the request message to a terminal of the red envelope sender. On the terminal of the red envelope sender, the request information is displayed in a form of prompt information at the red envelope message. For example, the request information is shown in a control named “+2 Request to re-send” in 402 in FIG. 4. The message backend may further transmit callback information to the terminal of the red envelope receiver, and display the request information at the red envelope message on the terminal of the red envelope receiver.

On the terminal of the red envelope sender, the red envelope sender may trigger the prompt information to display a request list. The request list includes a user identifier of each request user. On the terminal of the red envelope sender, the red envelope sender may trigger the red envelope re-sending control to re-send the red envelope. If the red envelope sender triggers the red envelope re-sending control, the terminal of the red envelope sender automatically obtains information such as a red envelope number and a red envelope amount from the red envelope message, to quickly generate a new red envelope (i.e., red envelope re-sending). The terminal of the red envelope sender transmits a red envelope sending request corresponding to the new red envelope to a red envelope backend, so that the red envelope backend enters a red envelope sending process. In some embodiments, if the request of the requesting user succeeds, a prompt message may be displayed on the message page. Content and a form of the prompt message are not limited in this embodiment of this application.

It may be learned from the above that, in this embodiment of this application, the message page of the client may be displayed, the message page including the at least one red envelope message; the red envelope request control is displayed in response to the triggering operation performed on the red envelope message if all red envelopes in the red envelope message are claimed; and in response to the triggering operation performed on the red envelope request control, the red envelope re-sending request is transmitted to the terminal of the user that transmits the red envelope message, so that the terminal of the user that transmits the red envelope message transmits the at least one red envelope re-sending message based on the red envelope re-sending request. In this embodiment of this application, when a user needs to send an electronic red envelope, the user may obtain information about a displayed red envelope by triggering the re-sending control on a terminal, to send a new red envelope. Through this embodiment of this application, the user does not need to set the red envelope from the very beginning, thereby improving efficiency of sending the electronic red envelope by the user.

According to the method described in the above embodiments, a detailed description is further provided below by using examples.

In this embodiment, a description is provided in combination with the system in FIG. 1.

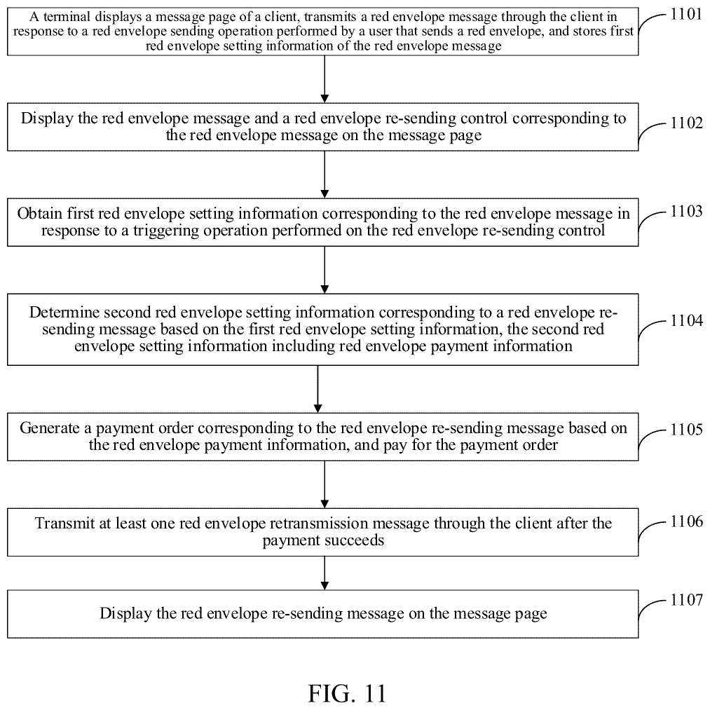

As shown in FIG. 11, a specific process of an electronic red envelope sending method of this embodiment may be as follows:

1101: A terminal displays a message page of a client, transmits a red envelope message through the client in response to a red envelope sending operation performed by a user that sends a red envelope, and stores first red envelope setting information of the red envelope message.

Currently, only one electronic red envelope can be sent each time. After the user sending the red envelope transmits one red envelope message, the electronic red envelope will be quickly grabbed. To maintain red envelope grabbing atmosphere among users, another red envelope needs to be sent quickly, i.e., the same red envelope sending process needs to be repeated, which is very cumbersome.

In this embodiment of this application, the user may open the client, clicks/taps any message page, and select a red envelope for sending.

1102: Display the red envelope message and a red envelope re-sending control corresponding to the red envelope message on the message page.

After the red envelope is sent, a bubble and a countdown exist at a left corner below the red envelope message that is just transmitted on the message page shown in 301 in FIG. 3. The user may click/tap or touch and hold the bubble to select a number of identical red envelopes for re-sending (to be specific, a red envelope amount, a red envelope number, and a blessing sentence are identical as those of the red envelope message that is just transmitted, so that the user may directly replicate the red envelope message that is just transmitted, to omit re-entering). The user may click/tap the bubble to retransmit one red envelope message, or may touch and hold and slide the bubble leftward/rightward to control a re-sending number.

To prompt the user to perform operations in the red envelope re-sending duration, in some embodiments, the red envelope re-sending control may be configured with a corresponding red envelope re-sending countdown, and the red envelope re-sending countdown is less than or equal to the preset red envelope re-sending duration.

The red envelope re-sending countdown may be “10 s” or “60 s” shown in 404 in FIG. 4.

The red envelope re-sending control may be configured in such a way that the user may re-send the red envelope by clicking/tapping or touching and holding the gray bubble within the countdown. If the countdown ends, the bubble disappears, and the user cannot replicate the red envelope for re-sending.

1103: Obtain first red envelope setting information corresponding to the red envelope message in response to a triggering operation performed on the red envelope re-sending control.

The triggering operation performed on the red envelope re-sending control may be an independent operation. To avoid a waste of terminal resources as a result of a misoperation of the user, the triggering operation may be a set of continuous operations. As shown in FIG. 5, the triggering operation may include a first triggering sub-operation performed on the control “+Re-send” in 501 in FIG. 5 and a second triggering sub-operation performed on a control “Send” in 502 in FIG. 5.

For example, after the user clicks/taps or touches and holds and slides the small bubble and then releases the bubble, a horizontal floating bubble for confirmation appears to prompt the user whether to re-send the red envelope. If the user clicks/taps “Send,” a payment cashier is directly pulled up for payment, and the red envelope is sent after the payment succeeds. If the user performs no operation, i.e., performs no clicking/tapping within a specific time period, the bubble disappears, and a current red envelope re-sending task ends.

1104: Determine second red envelope setting information corresponding to a red envelope re-sending message based on the first red envelope setting information, the second red envelope setting information including red envelope payment information.

Specifically, a data structure model of the red envelope message or the red envelope re-sending message may include the following parameters: an identity (ID) of a red envelope sender (NSString*senderUID); a nickname of the red envelope sender (NSString “senderNickName); whether the message is a message transmitted in person (BOOL isSelfMsg); a red envelope order number (NSString*billNo), a signature (sdkNsString*authKey): the field is transparently transmitted by a payment application through a payment backend, and then transmitted to the payment application by the terminal; a red envelope payment mode identifier (NSInteger payFlag); a red envelope type (NSInteger redType), which is configured for distinguishing a red envelope message, a transfer message, and a split bill message; a red envelope message type (NSInteger msgType); a red envelope channel (a red envelope message type defined by a payment software development kit (SDK) and the payment backend, NSInteger redChannel); a red envelope subChannel (a subtype of the same redChannel, which, for example, may be configured for distinguishing between different red envelope solitaire modes) (NSInteger subChannel); a red envelope title (NSString *title); a red envelope cover ID (NSInteger skinlD); a dedicated red envelope user UIN list (NSArray−NSNumber>*grapUins); a red envelope claiming status (NSNumber “openState); a total red envelope amount; and a red envelope number.

The total red envelope amount and the red envelope number are new parameters set for the electronic red envelope sending method for quickly re-sending a red envelope provided in this embodiment of this application. The total red envelope amount indicates a total electronic red envelope amount corresponding to the red envelope messages or the red envelope re-sending message. The red envelope number is a message number of red envelope re-sending messages.

In some embodiments, if a response needs to be achieved for the red envelope re-sending request that request the red envelope re-sending message, the data architecture model further needs to include a requesting user list. The requesting user list includes information about a requesting user.

1105: Generate a payment order corresponding to the red envelope re-sending message based on the red envelope payment information, and pay for the payment order.

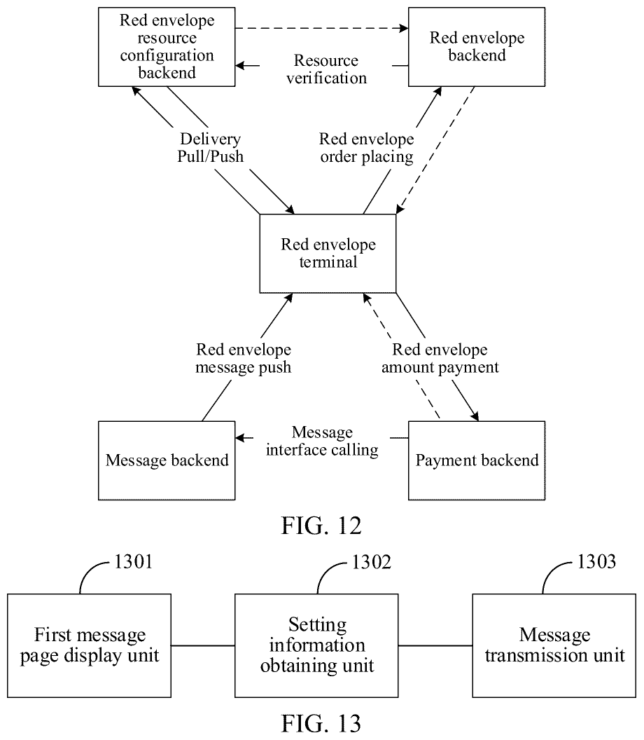

Specifically, an overall architecture of the red envelope solution may be shown in FIG. 12.

A red envelope terminal is configured for red envelope receiving/sending among friends and interaction with friends. A red envelope resource configuration backend is configured to output red envelope resource configuration data. A red envelope backend is mainly configured to receive a red envelope order placing request initiated by the red envelope terminal, and output a red envelope order token to the red envelope terminal for a subsequent payment process. The payment backend is mainly configured to complete the payment of the red envelope order, provide callback to the red envelope terminal after completing the payment, and asynchronously request a red envelope message backend interface. A message backend is configured to push a red envelope message to a specified friend after receiving a red envelope message transmission request. The red envelope terminal displays the red envelope message after receiving the red envelope message.

1106: Transmit at least one red envelope re-sending message through the client after the payment succeeds.

In the first operation, when the user edits a red envelope, the user needs to manually enter a red envelope number and a red envelope amount to initiate a red envelope request.

During quick red envelope re-sending, after the user sends a red envelope, since the red envelope message has information related to the red envelope stored therein, when the user clicks/taps or touches and holds a message bubble to initiate “Quickly re-send the red envelope,” the terminal obtains information such as a red envelope number and a red envelope amount from the red envelope message, enters red envelope information based on the information, and directly transmits a red envelope request to the backend.

1107: Display the red envelope re-sending message on the message page.

It may be learned from the above that, in this embodiment of this application, the message page of the client may be displayed, the message page including the at least one red envelope message, the red envelope re-sending control being displayed in red envelope message; the first red envelope setting information corresponding to the red envelope message is obtained in response to the triggering operation performed on the red envelope re-sending control; and the at least one red envelope re-sending message is transmitted through the client based on the first red envelope setting information. In this embodiment of this application, when a user needs to send an electronic red envelope, the user may obtain information about a displayed red envelope by triggering the re-sending control, to send a new red envelope. Through this embodiment of this application, the user does not need to set the red envelope from the very beginning, thereby improving efficiency of sending the electronic red envelope by the user.

To implement the above method more effectively, an embodiment of this application further provides a corresponding electronic red envelope sending apparatus. The electronic red envelope sending apparatus may be integrated in an electronic device used by a first user. Nouns in this embodiment have the same meanings as those in the above electronic red envelope sending method. For specific implementation details, reference may be made to the descriptions in the method embodiments.

Referring to FIG. 13, the apparatus includes a first message page display unit 1301, a setting information obtaining unit 1302, and a message transmission unit 1303.

The first message page display unit 1301 may be configured to display a message page of a client. The message page may include at least one red envelope message and a red envelope re-sending control corresponding to the red envelope message.

The setting information obtaining unit 1302 may be configured to obtain first red envelope setting information corresponding to the red envelope message in response to a triggering operation performed on the red envelope re-sending control.

The message transmission unit 1303 may be configured to transmit at least one red envelope re-sending message through the client based on the first red envelope setting information.

In some optional embodiments, the setting information obtaining unit 1302 may be configured to: display a re-sending confirmation control in response to the triggering operation performed on the red envelope re-sending control; and obtain the first red envelope setting information corresponding to the red envelope message in response to a triggering operation performed on the re-sending confirmation control.

In some optional embodiments, the setting information obtaining unit 1302 may be configured to: display a number prompt identifier in response to a re-sending number setting operation performed on the red envelope re-sending control, the number prompt identifier indicating a message number of red envelope re-sending messages corresponding to the re-sending number setting operation; and obtain the first red envelope setting information corresponding to the red envelope message in response to a number setting ending event.

In some optional embodiments, the message transmission unit 1303 may be configured to display a red envelope message setting page based on the first red envelope setting information. The red envelope message setting page may include the first red envelope setting information. The message transmission unit may be configured to: determine second red envelope setting information in response to an information modification operation directed to the first red envelope setting information on the red envelope message setting page; and transmit the red envelope re-sending message through the client based on the second red envelope setting information, setting information of the red envelope re-sending message including the second red envelope setting information.

In some optional embodiments, the first red envelope setting information and the second red envelope setting information each may include at least one of a red envelope number, a red envelope amount, a red envelope type, a red envelope cover, and a red envelope remark corresponding to the red envelope re-sending message.

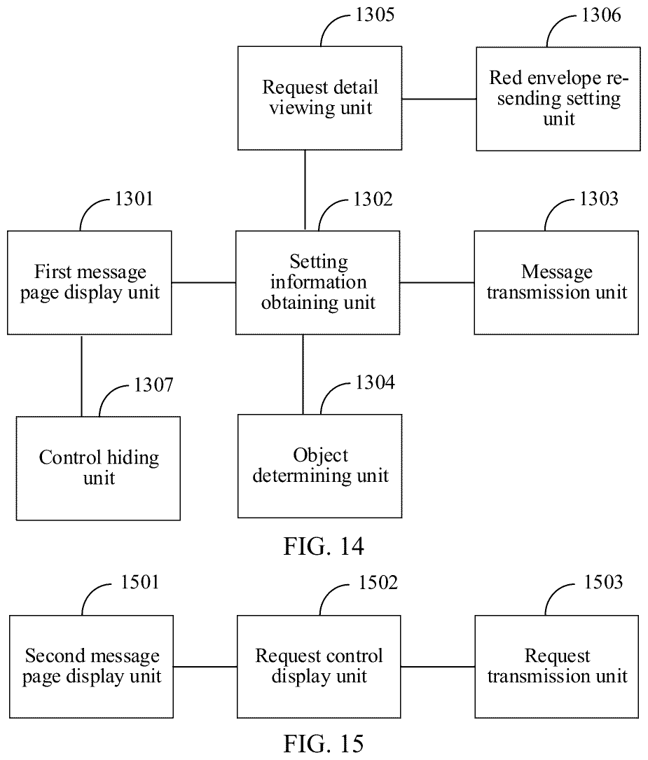

In some optional embodiments, as shown in FIG. 14, the electronic red envelope sending apparatus provided in this embodiment of this application may further include an object determining unit 1304.

The object determining unit 1304 may be configured to: display a red envelope receiving object selection page. The red envelope receiving object selection page may include an object identifier of at least one red envelope receiving object. The object determining unit may be configured to determine at least one target red envelope receiving object in response to a receiving object selection operation performed on the red envelope receiving object selection page.

The message transmission unit 1303 may be configured to transmit the at least one red envelope re-sending message to the target red envelope receiving object through the client.

In some optional embodiments, the object identifier of the at least one red envelope receiving object includes at least one of an object identifier of a current session object corresponding to the message page and an object identifier of an associated object associated with a logged-in account in the client.

In some optional embodiments, the electronic red envelope sending apparatus provided in this embodiment of this application may further include a request detail viewing unit 1305.

The request detail viewing unit 1305 may be configured to: receive a red envelope re-sending request, and display a request detail viewing control in the red envelope message based on the red envelope re-sending request; and display a request detail page in response to a triggering operation performed on the request detail viewing control. The request detail page may include a user identifier of a requesting user that requests red envelope re-sending.

In some optional embodiments, the electronic red envelope sending apparatus provided in this embodiment of this application may further include a red envelope re-sending setting unit 1306.

The red envelope re-sending setting unit 1306 may be configured to: determine third red envelope setting information in response to a triggering operation performed on the red envelope re-sending setting control; obtain the first red envelope setting information corresponding to the red envelope message; and transmit the at least one red envelope re-sending message through the client based on the first red envelope setting information and the third red envelope setting information.

In some optional embodiments, the red envelope re-sending setting control may include a receiving object setting control corresponding to each requesting user. The red envelope re-sending setting unit 1306 may be configured to use, in response to a triggering operation performed on at least one receiving object setting control, a requesting user corresponding to the receiving object setting control as the red envelope receiving object; and determine the third red envelope setting information based on object information of the red envelope receiving object.

In some optional embodiments, the electronic red envelope sending apparatus provided in this embodiment of this application may further include a requesting user display unit. The requesting user display unit may be configured to display a red envelope detail page in response to a triggering operation performed on the red envelope message. The red envelope detail page may include the user identifier of the requesting user that requests red envelope re-sending, and the user identifier of the requesting user is obtained through a red envelope re-sending request transmitted by a client of the requesting user.

In some optional embodiments, a red envelope re-sending countdown corresponds to the red envelope re-sending control, the red envelope re-sending countdown being less than or equal to a preset red envelope re-sending duration.

In some optional embodiments, the electronic red envelope sending apparatus provided in this embodiment of this application may further include a control hiding unit 1307.

The control hiding unit 1307 may be configured to: obtain a message transmission duration of the red envelope message, and adjust a display effect of the red envelope re-sending control when the message transmission duration is greater than the preset red envelope re-sending duration.

In some optional embodiments, the setting information obtaining unit 1302 may be configured to determine fourth red envelope setting information corresponding to the red envelope re-sending message based on the first red envelope setting information. The fourth red envelope setting information may include red envelope payment information and the object information of the red envelope receiving object. The setting information obtaining unit may be configured to: generate a payment order corresponding to the red envelope re-sending message based on the red envelope payment information, and perform a payment confirmation operation on the payment order; and transmit, through the client, the at least one red envelope re-sending message to a client of the red envelope receiving object based on the object information.

It may be learned from the above that, according to the electronic red envelope sending apparatus, the message page of the client may be displayed, the message page including the at least one red envelope message, the red envelope re-sending control being displayed in red envelope message; the first red envelope setting information corresponding to the red envelope message is obtained in response to the triggering operation performed on the red envelope re-sending control; and the at least one red envelope re-sending message is transmitted through the client based on the first red envelope setting information. In this embodiment of this application, when a user needs to send an electronic red envelope, the user may obtain information about a displayed red envelope by triggering the re-sending control, to send a new red envelope. Through this embodiment of this application, the user does not need to set the red envelope from the very beginning, thereby improving efficiency of sending the electronic red envelope by the user.

To implement the electronic red envelope sending method provided in the embodiments of this application more effectively, an embodiment further provides another electronic red envelope sending apparatus. The electronic red envelope sending apparatus may be integrated in an electronic device used by an associated user of a first user. Nouns in this embodiment have the same meanings as those in the above electronic red envelope sending method. For specific implementation details, reference may be made to the descriptions in the method embodiments.

Referring to FIG. 15, the apparatus includes a second message page display unit 1501, a request control display unit 1502, and a request transmission unit 1503.

The second message page display unit 1501 may be configured to display a message page of a client. The message page may include at least one red envelope message.

The request control display unit 1502 may be configured to display a red envelope request control in response to a triggering operation performed on the red envelope message if all red envelopes in the red envelope message are claimed.

The request transmission unit 1503 may be configured to transmit, in response to a triggering operation performed on the red envelope request control, a red envelope re-sending request to a terminal corresponding to a user that transmits the red envelope message, so that the terminal transmits at least one red envelope re-sending message based on the red envelope re-sending request.

In some optional embodiments, the request transmission unit 1503 may be configured to: display a request information setting page in response to the triggering operation performed on the red envelope request control; determine red envelope request information in response to a request information setting operation performed on the request information setting page; and generate the red envelope re-sending request based on the red envelope request information, and transmit the red envelope re-sending request to the terminal corresponding to the user that transmits the red envelope message.

It may be learned from the above that, according to the electronic red envelope sending apparatus, the message page of the client may be displayed, the message page including the at least one red envelope message, the red envelope re-sending control being displayed in red envelope message; the first red envelope setting information corresponding to the red envelope message is obtained in response to the triggering operation performed on the red envelope re-sending control; and the at least one red envelope re-sending message is transmitted through the client based on the first red envelope setting information. In this embodiment of this application, when a user needs to send an electronic red envelope, the user may obtain information about a displayed red envelope by triggering the re-sending control, to send a new red envelope. Through this embodiment of this application, the user does not need to set the red envelope from the very beginning, thereby improving efficiency of sending the electronic red envelope by the user.

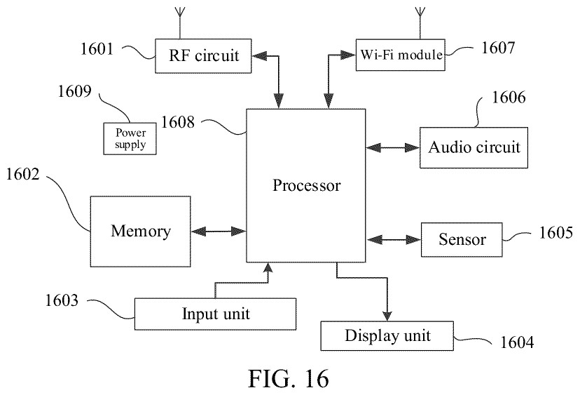

In addition, an embodiment of this application further provides an electronic device. The electronic device may be a terminal, a server, or the like. FIG. 16 is a schematic structural diagram of an electronic device according to an embodiment of this application. Specifically,
the electronic device may include components such as a radio frequency (RF) circuit 1601, a memory 1602 including one or more computer-readable storage media, an input unit 1603, a display unit 1604, a sensor 1605, an audio circuit 1606, a wireless fidelity (Wi-Fi) module 1607, a processor 1608 including one or more processing cores, and a power supply 1609. A person skilled in the art may understand that a structure of the electronic device shown in FIG. 16 does not constitute a limitation on the electronic device, and the electronic device may include more or fewer components than those shown in the figure, or some merged components, or different component arrangements.

The RF circuit 1601 may be configured to receive and transmit a signal during information transceiving or during a call. In particular, downlink information of a base station is processed by one or more processors 1608 after being received. In addition, involved uplink data is transmitted to the base station. Generally, the RF circuit 1601 includes but is not limited to an antenna, at least one amplifier, a tuner, one or more oscillators, a subscriber identity module (SIM) card, a transceiver, a coupler, a low noise amplifier (LNA), and a duplexer. In addition, the RF circuit 1601 may further communicate with a network and another device through wireless communication. The wireless communication may be performed through any communication standard or protocol, including but not limited to a Global System of Mobile Communication (GSM), a general packet radio service (GPRS), code division multiple access (CDMA), wideband code division multiple access (WCDMA), long term evolution (LTE), e-mail, and a short messaging service (SMS).

The memory 1602 may be configured to store a software program and a module, and the processor 1608 executes various function applications and performs data processing by running the software program and the module stored in the memory 1602. The memory 1602 may mainly include a program storage area and a data storage area. The program storage area can store an operating system, an application required for at least one function (for example, a sound playback function or an image playback function), and the like. The data storage area can store data (for example, audio data and a phone book) and the like created based on use of the electronic device. In addition, the memory 1602 may include a high-speed random access memory (RAM), and may further include a non-volatile memory, such as at least one disk storage device, a flash memory device, or another volatile solid-state storage device. Correspondingly, the memory 1602 may further include a memory controller to provide access to the memory 1602 for the processor 1608 and the input unit 1603.

The input unit 1603 may be configured to receive inputted number or character information, and generate a keyboard, mouse, joystick, optical or trackball signal input related to user settings and function control. Specifically, in a specific embodiment, the input unit 1603 may include a touch-sensitive surface and another input device. The touch-sensitive surface is also referred to as a touchscreen or a touchpad, and may collect a touch operation (for example, an operation performed by a user on or near the touch-sensitive surface by using any suitable object or accessory such as a finger or a touchpen) performed on or near the touch-sensitive surface, and drive a corresponding connection apparatus based on a preset program. In some embodiments, the touch-sensitive surface may include a touch detection apparatus and a touch controller. The touch detection apparatus is configured to detect a touch orientation of the user, detect a signal brought by the touch operation, and transmit the signal to the touch controller. The touch controller is configured to receive the touch information from the touch detection apparatus, convert the touch information into a touch point coordinate, and transmit the touch point coordinate to the processor 1608, and can receive and execute a command transmitted by the processor 1608. In addition, the touch-sensitive surface may be implemented in various types such as a resistor, a capacitor, an infrared ray, or a surface acoustic wave. In addition to the touch-sensitive surface, the input unit 1603 may further include the another input device. Specifically, the another input device may include but is not limited to one or more of a physical keyboard, a function button (such as a volume control button or a power button), a trackball, a mouse, and a joystick.

The display unit 1604 may be configured to display information inputted by the user or information provided to the user, and various GUIs of the electronic device. The GUIs may be composed of graphics, texts, icons, videos, and any combination thereof. The display unit 1604 may include a display panel. In some embodiments, the display panel may be configured in a form of a liquid crystal display (LCD), an organic light-emitting diode (OLED), or the like. Further, the touch-sensitive surface may cover the display panel. After the touch operation performed on or near the touch-sensitive surface is detected, the touch operation is transmitted to the processor 1608 to determine a type of the touch event, and then the processor 1608 provides a corresponding visual output on the display panel based on the type of the touch event. Although the touch-sensitive surface and the display panel implement the input and output functions as two independent components in FIG. 16, in some embodiments, the touch-sensitive surface and the display panel may be integrated to implement the input and output functions.

The electronic device may further include at least one sensor 1605, such as an optical sensor, a motion sensor, and another sensor. Specifically, the optical sensor may include an ambient light sensor and a proximity sensor. The ambient light sensor can adjust brightness of the display panel based on brightness of an ambient light, and the proximity sensor can turn off the display panel and/or backlight when the electronic device is moved to an ear. As a motion sensor, a gravity acceleration sensor can detect a magnitude of an acceleration in all directions (generally, three axes), and can detect a magnitude and a direction of gravity when the gravity acceleration sensor is at rest, and may be configured for applications for mobile phone pose recognition (such as switching between landscape and portrait modes, a relevant game, and magnetometer pose calibration), a vibration recognition-related function (such as a pedometer and tapping), and the like. Other sensors such as a gyroscope, a barometer, a hygrometer, a thermometer, and an infrared sensor that may be further configured on electronic device are not described in detail herein.

The audio circuit 1606, a speaker, and a microphone can provide an audio interface between the user and the electronic device. The audio circuit 1606 can convert received audio data into an electrical signal, and transmit the electrical signal to the speaker. The speaker converts the electrical signal into a sound signal for output. In another aspect, the microphone converts a collected sound signal into an electrical signal, and the audio circuit 1606 receives the electrical signal, converts the electrical signal into audio data, and outputs the audio data to the processor 1608 for processing, and the audio data is transmitted to another electronic device through the RF circuit 1601. Alternatively, the audio data is outputted to the memory 1602 for further processing. The audio circuit 1606 may further include an earplug jack, to provide communication between a peripheral headset and the electronic device.

Wi-Fi is a near field wireless transmission technology. The electronic device may help the user transmit and receive an email, browse a webpage, access streaming media, and the like through the Wi-Fi module 1607. The Wi-Fi module provides the user with wireless broadband Internet access. Although FIG. 16 shows the Wi-Fi module 1607, the Wi-Fi module is not an essential component of the electronic device, and may be omitted as needed without changing the essence of this application.

The processor 1608 is a control center of the electronic device, which is connected to all parts of the entire electronic device by using various interfaces and lines, and executes various functions of the electronic device and processes data by running or executing the software program and/or the module stored in the memory 1602 and calling data stored in the memory 1602. In some embodiments, the processor 1608 may include one or more processing cores. In some embodiments, an application processor and a modem processor may be integrated in the processor 1608. The application processor mainly processes an operating system, a UI, an application, and the like. The modem processor mainly processes wireless communication. The modem processor may alternatively not be integrated in the processor 1608.

The electronic device further includes the power supply 1609 (such as a battery) configured to supply power to all of the components. In some embodiments, the power supply may be logically connected to the processor 1608 through a power management system, to implement functions such as charging, discharging, and power consumption management through the power management system. The power supply 1609 may further include any component such as one or more direct current or alternating current power supplies, a recharging system, a power failure detection circuit, a power converter or inverter, and a power status indicator.

Although not shown, the electronic device may further include a camera, a Bluetooth module, and the like, which are not described in detail herein. Specifically, in this embodiment, the processor 1608 in the electronic device loads executable files corresponding to processes of one or more applications into the memory 1602 based on the following instructions, and the processor 1608 runs the applications stored in the memory 1602, thereby implementing various functions. The instructions include:
displaying a message page of a client, the message page including at least one red envelope message, a red envelope re-sending control being displayed in the red envelope message;
obtaining first red envelope setting information corresponding to the red envelope message in response to a triggering operation performed on the red envelope re-sending control; and
transmitting at least one red envelope re-sending message through the client based on the first red envelope setting information; and/or
displaying a message page of a client, the message page including at least one red envelope message;
displaying a red envelope request control in response to a triggering operation performed on the red envelope message if all red envelopes in the red envelope message are claimed; and
transmitting, in response to a triggering operation performed on the red envelope request control, a red envelope re-sending request to a user that transmits the red envelope message, so that the user that transmits the red envelope message transmits at least one red envelope re-sending message based on the red envelope re-sending request.

A person of ordinary skill in the art may understand that, all or some of the operations of the methods in the above embodiments may be completed by using instructions, or may be completed by using the instructions by controlling relevant hardware. The instructions may be stored in a computer-readable storage medium, and may be loaded and executed by a processor.

For this purpose, an embodiment of this application provides a computer-readable storage medium having a plurality of instructions stored therein. The instructions may be loaded by a processor, to perform the operations in any one of the electronic red envelope sending methods provided in the embodiments of this application. For example, the instructions can perform the following operations:
displaying a message page of a client, the message page including at least one red envelope message, a red envelope re-sending control being displayed in the red envelope message;
obtaining first red envelope setting information corresponding to the red envelope message in response to a triggering operation performed on the red envelope re-sending control; and
transmitting at least one red envelope re-sending message through the client based on the first red envelope setting information; and/or
displaying a message page of a client, the message page including at least one red envelope message;
displaying a red envelope request control in response to a triggering operation performed on the red envelope message if all red envelopes in the red envelope message are claimed; and
transmitting, in response to a triggering operation performed on the red envelope request control, a red envelope re-sending request to a user that transmits the red envelope message, so that the user that transmits the red envelope message transmits at least one red envelope re-sending message based on the red envelope re-sending request.

For specific implementations of the above operations, reference may be made to the above embodiments, and the details are not described herein again.

The computer-readable storage medium may include a read-only memory (ROM), a RAM, a disk, an optical disc, or the like.

Since the instructions stored in the computer-readable storage medium can perform the operations in any one of the electronic red envelope sending methods provided in the embodiments of this application, the instructions can implement beneficial effects that can be implemented by any one of the electronic red envelope sending methods provided in the embodiments of this application. For details, reference is made to the above embodiments, which are not described herein again.

According to an aspect of this application, a computer program product or a computer program is further provided. The computer program product or the computer program includes computer instructions, the computer instructions being stored in a computer-readable storage medium. A processor of an electronic device reads the computer instructions from the computer-readable storage medium, and executes the computer instructions, so that the electronic device performs the electronic red envelope sending methods provided in the optional implementations of the above embodiments.

The electronic red envelope sending method and apparatus, the electronic device, and the storage medium provided in the embodiments of this application are described above in detail. The principles and the implementations of this application are illustrated by using specific examples. The descriptions of the above embodiments are merely configured for facilitating understanding of the method of this application and the core idea thereof. In addition, a person skilled in the art may make modifications to the specific implementations and the application scope based on the idea of this application. In summary, the content of this specification is not to be construed as a limitation on this application.

What is claimed is:

1. An electronic red envelope sending method, performed by a terminal, comprising:
displaying a message page of a client, the message page including a red envelope message and a red envelope re-sending control corresponding to the red envelope message;
obtaining red envelope setting information corresponding to the red envelope message in response to a triggering operation performed on the red envelope re-sending control; and
transmitting a red envelope re-sending message through the client based on the red envelope setting information.

2. The method according to claim 1, wherein obtaining the red envelope setting information message in response to the triggering operation performed on the red envelope re-sending control includes:
displaying a re-sending confirmation control in response to the triggering operation performed on the red envelope re-sending control; and
obtaining the red envelope setting information in response to a triggering operation performed on the re-sending confirmation control.

3. The method according to claim 1, wherein obtaining the red envelope setting information in response to the triggering operation performed on the red envelope re-sending control includes:
displaying a number prompt identifier in response to a re-sending number setting operation performed on the red envelope re-sending control, the number prompt identifier indicating a message number of red envelope re-sending messages corresponding to the re-sending number setting operation; and
obtaining the red envelope setting information corresponding to the red envelope message in response to a number setting ending event.

4. The method according to claim 1, wherein:
the red envelope setting information is first red envelope setting information; and
transmitting the red envelope re-sending message includes:
displaying a red envelope message setting page based on the first red envelope setting information, the red envelope message setting page including the first red envelope setting information;
determining second red envelope setting information in response to an information modification operation directed to the first red envelope setting information on the red envelope message setting page; and
transmitting the red envelope re-sending message through the client based on the second red envelope setting information, setting information of the red envelope re-sending message including the second red envelope setting information.

5. The method according to claim 4, wherein the first red envelope setting information and the second red envelope setting information each includes at least one of a red envelope number, a red envelope amount, a red envelope type, a red envelope cover, and a red envelope remark.

6. The method according to claim 1, further comprising, before transmitting the red envelope re-sending message:
displaying a red envelope receiving object selection page, the red envelope receiving object selection page including at least one object identifier each corresponding to one of at least one red envelope receiving object; and
determining a target red envelope receiving object in response to a selection operation performed on one of the at least one object identifier;
wherein transmitting the red envelope re-sending message includes:
transmitting the red envelope re-sending message to the target red envelope receiving object through the client.

7. The method according to claim 6, wherein the at least one object identifier include at least one of an object identifier of a current session object corresponding to the message page and an object identifier of an associated object associated with a logged-in account in the client.

8. The method according to claim 1, further comprising, before obtaining the red envelope setting information:
receiving a red envelope re-sending request, and displaying a request detail viewing control in the red envelope message based on the red envelope re-sending request; and
displaying a request detail page in response to a triggering operation performed on the request detail viewing control, the request detail page including a user identifier of a requesting user that requests red envelope re-sending.

9. The method according to claim 8,
wherein:
the request detail page comprises a red envelope re-sending setting control; and
the red envelope setting information is first red envelope setting information;
the method further comprising:
determining second red envelope setting information in response to a triggering operation performed on the red envelope re-sending setting control;
obtaining the first red envelope setting information corresponding to the red envelope message; and
transmitting the red envelope re-sending message through the client based on the first red envelope setting information and the second red envelope setting information.

10. The method according to claim 9, wherein:
the red envelope re-sending setting control includes a receiving object setting control corresponding to the requesting user; and
determining the second red envelope setting information in response to the triggering operation performed on the red envelope re-sending setting control includes:
determining, in response to a triggering operation performed on the receiving object setting control, the requesting user as the red envelope receiving object; and
determining the second red envelope setting information based on object information of the red envelope receiving object.

11. The method according to claim 1, further comprising, before obtaining the red envelope setting information:
displaying a red envelope detail page in response to a triggering operation performed on the red envelope message, the red envelope detail page including a user identifier of a requesting user that requests red envelope re-sending, and the user identifier being obtained through a red envelope re-sending request transmitted by a client of the requesting user.

12. The method according to claim 1, wherein a red envelope re-sending countdown corresponds to the red envelope re-sending control, the red envelope re-sending countdown being less than or equal to a preset red envelope re-sending duration.

13. The method according to claim 1, further comprising:
obtaining a message transmission duration of the red envelope message; and
adjusting a display effect of the red envelope re-sending control in response to the message transmission duration being greater than a preset red envelope re-sending duration.

14. The method according to claim 1, wherein:
the red envelope setting information is first red envelope setting information; and
transmitting the red envelope re-sending message includes:
determining second red envelope setting information corresponding to the red envelope re-sending message based on the first red envelope setting information, the second red envelope setting information including red envelope payment information and object information of a red envelope receiving object;
generating a payment order corresponding to the red envelope re-sending message based on the red envelope payment information, and performing a payment confirmation operation on the payment order; and
transmitting, through the client, the red envelope re-sending message to a client of the red envelope receiving object based on the object information.

15. A non-transitory computer-readable storage medium storing one or more executable instructions that, when loaded and executed by at least one processor of an electronic device, cause the electronic device to perform the method of claim 1.

16. An electronic red envelope sending method, performed by a terminal, comprising:
displaying a message page of a client, the message page including a red envelope message;
displaying a red envelope request control in response to a triggering operation performed on the red envelope message and all red envelopes in the red envelope message having been claimed; and
transmitting, in response to a triggering operation performed on the red envelope request control, a red envelope re-sending request to another terminal corresponding to a user that transmits the red envelope message.

17. The method according to claim 16, wherein transmitting the red envelope re-sending request includes:
displaying a request information setting page;
determining red envelope request information in response to a request information setting operation performed on the request information setting page; and
generating the red envelope re-sending request based on the red envelope request information, and transmitting the red envelope re-sending request to the other terminal corresponding to the user that transmits the red envelope message.

18. An electronic device comprising:
at least one memory storing at least one application; and
at least one processor configured to run the at least one application to perform the method of claim 16.

19. A non-transitory computer-readable storage medium storing one or more executable instructions that, when loaded and executed by at least one processor of an electronic device, cause the electronic device to perform the method of claim 16.

20. An electronic device comprising:
at least one memory storing at least one application; and
at least one processor configured to run the at least one application to:
display a message page of a client, the message page including a red envelope message and a red envelope re-sending control corresponding to the red envelope message;
obtain red envelope setting information corresponding to the red envelope message in response to a triggering operation performed on the red envelope re-sending control; and
transmit a red envelope re-sending message through the client based on the red envelope setting information.
